(19) United States
(12) Patent Application Publication
(10) Pub. No.: US 2006/0009183 A1
(43) Pub. Date: Jan. 12, 2006

(54) Low frequency attenuating circuit

(76) Inventors: Tsuyoshi Koike, Tokyo (JP); Hiroshi Miyagi, Yokohama (JP)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/518,115

(22) PCT Filed: Jun. 5, 2003
(86) PCT No.: PCT/JP03/07157

§ 371 Date: Jul. 19, 2005

(30) Foreign Application Priority Data
Jun. 18, 2002 (JP) 2002-177280

(51) Int. Cl. H04B 1/00; H04B 1/06; H04B 1/10

(52) U.S. Cl. 455/249.1; 455/63.1; 455/303

(57) ABSTRACT

An FM/AM switch (31) selects either an FM detected signal or an AM detected signal. A capacitor (4) is provided to cut the DC component of the FM detected signal. A low-cut frequency switch (33) selects a resistor designated by a control, signal from among resistors (Ra through Rc). A high-pass filter is constituted by the capacitor (4) and a resistor selected by the low-cut frequency switch (33). The cut-off frequency of this high-pass filter is adjusted by the selection of a resistor.

### TECHNICAL FIELD

The present invention relates to a low frequency attenuation circuit for attenuating the low frequency components of an AM/FM detected signal and a radio receiver.

### BACKGROUND ART

A radio receiver for receiving AM broadcast waves usually comprises a low frequency attenuation circuit (AM low-cut circuit) for attenuating frequency components of approximately 100 Hz or less of an AM detected signal.

FIG. 1 shows the configuration of a radio receiver with an existing low frequency attenuation circuit. Here, an FM/AM radio receiver capable of receiving both FM and AM broadcast waves as one example of a radio receiver.

An FM signal is received by an FM front-end circuit 1, amplified by an IF amplifier 2 and FM-detected by an FM detection circuit 3. Then, after the direct current (DC) component of this FM detected signal is cut by a capacitor 4 and the FM detected signal is outputted to a speaker 6. The FM detected signal is stereo-demodulated by a stereo demodulation unit 5.

An AM signal is received by an AM front-end circuit 11, amplified by an IF amplifier 12 and AM-detected by an AM detection circuit 13. Then, after the low frequency component (such as components of 100 Hz or less) of this AM detected signal is cut by a low frequency attenuation circuit 14 and the FM detected signal is outputted to the speaker 6.

FIG. 2A is one circuit diagram of the low frequency attenuation circuit 14. The low frequency attenuation circuit 14 comprises an Op amplifier 21, resistors R1-R3 and a capacitor C. The output of the AM detection circuit 13 is supplied to the inversion input terminal of the amplifier 21 via the resistor R1, and also supplied to the non-inversion input terminal of the OP amplifier 21 via the resistor R2. In this case, the non-inversion input terminal of the OP amplifier 21 is grounded via the capacitor C. The output of the OP amplifier 21 is fed back to the inversion input terminal of the amplifier 21 via the resistor R3.

The low frequency attenuation circuit 14 with the above-mentioned configuration operates in a state shown in FIG. 2B for high frequency component. Specifically, since the impedance of the capacitor C is low for high frequency component, the non-inversion input terminal of the OP amplifier 21 is grounded. Therefore, the amplitude of an output signal Vₒᵤₜ is proportional to that of an input signal Vᵢₙ.

However, the low frequency attenuation circuit 14 operates in a state shown in FIG. 2C for low frequency component. Specifically, in a case of resistor R1 equals to =resistor R2, to the non-inversion input terminal of the OP amplifier 21, a signal with the same phase as its inversion input terminal is inputted. Therefore, in this case, the amplitude of the output signal Vₒᵤₜ becomes small.

As described above, the low frequency attenuation circuit 14 passes high frequency component and attenuates low frequency component.

Generally, a small-size and low-cost radio receiver is required. More specifically, an integrated (finally one-chip) receiving circuit is required.

However, in order to attenuate frequency component of approximately 100 Hz or less by the low frequency attenuation circuit 14 shown in FIG. 2A, the capacitor C must be large. In this case, the capacitor C cannot be formed in an integrated circuit (IC), and must be attached as a so-called “external component”. As a result, the mounting area of the low frequency attenuation circuit 14 becomes large, and cost reduction cannot be achieved.

### DISCLOSURE OF INVENTION

An object of the present invention is to realize a small low frequency attenuation circuit for attenuating the low frequency component of AM/FM detected signals.

The low frequency attenuation circuit of the present invention is use in an FM/AM radio receiver. The low frequency attenuation circuit comprises a first switch for selecting an FM detected signal or AM detected signal; a capacitor provided on the output side of the first switch; a plurality of resistors provided on the output side of the first switch; and a second switch constituting a high-pass filter for the AM detected signal using a resistor selected from the plurality of resistors and the capacitor when the first switch selects the AM detected signal. In this case, the first switch, the plurality of resistors and the second switch may be formed in one IC.

In the low frequency attenuation circuit, the capacitor is used both to cut the DC component of the FM detected signal and to attenuate the low frequency component of the AM detected component. Accordingly, there is no need to provide a capacitor only used to attenuate the low frequency component of the AM detected signal. As a result, small circuit scale, circuit integration and cost reduction of a radio receiver can be realized.

The cut-off frequency of the high-pass filter for the AM detected signal can be adjusted by selecting an appropriate resistor from the plurality of resistors. Accordingly, a desired frequency component can be easily attenuated.

If the FM/AM radio receiver comprises a high frequency attenuation circuit for attenuating the high-frequency component of a detected signal, the second switch may select a resistor among the plurality of resistors, based on the operation of the high frequency attenuation circuit. By linking the low frequency attenuation operation with the high frequency operation, suitable hearing sense can be easily obtained.

The present invention can be configured so as no only to attenuate the low frequency component of an AM detected signal but also to attenuate the low frequency component of an FM detected signal.

### BRIEF DESCRIPTION OF DRAWINGS

FIG. 1 shows one radio receiver provided with an existing low frequency attenuation circuit.

FIGS. 2A through 2C explain the configuration and operation of the existing low frequency attenuation circuit.

FIG. 3 shows the configuration of the low frequency attenuation circuit of the embodiment.

FIG. 4 shows the characteristic of the high-pass filter of the embodiment.

FIG. 5 shows the configuration of a receiver provided with a low frequency attenuation function and a high frequency attenuation function.

FIG. 6 explains the control of the low frequency attenuation function and high frequency attenuation function.

FIG. 7 shows another embodiment of the resistor circuit.

FIG. 8 shows the configuration of the low frequency attenuation circuit of another embodiment.

### BEST MODE FOR CARRYING OUT THE INVENTION

The embodiments of the present invention are described below with reference to the drawings.

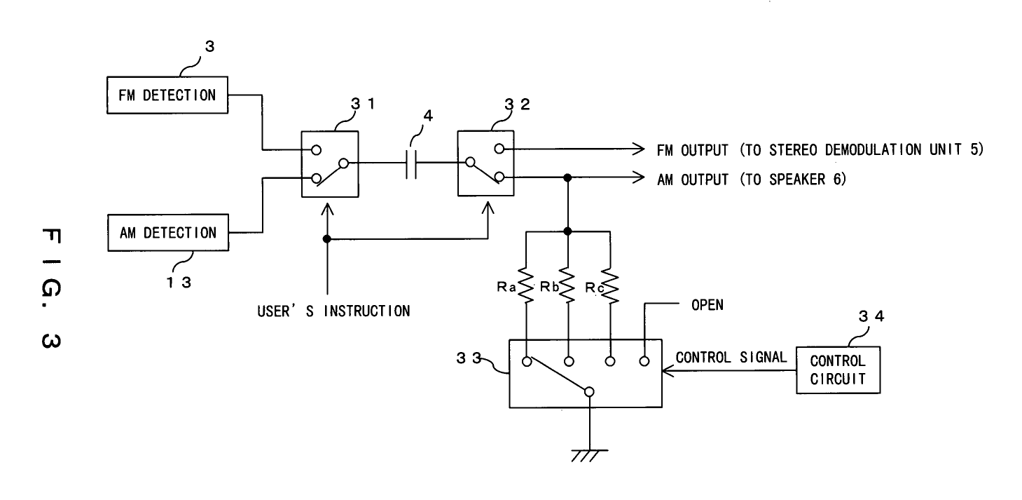

FIG. 3 shows the configuration of the low frequency attenuation circuit of the embodiment. This low frequency attenuation circuit is used to attenuate the low frequency component of an AM detected signal in an FM/AM radio receiver.

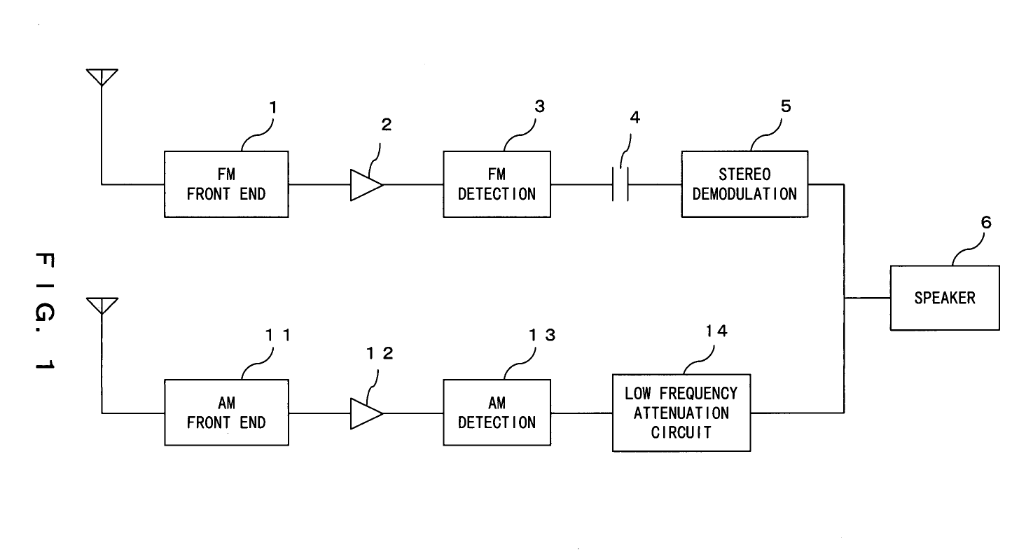

In FIG. 3, an FM/AM switch (first switch) 31 selects either an FM detected signal outputted from an FM detection circuit 3 or an AM detected signal outputted from an AM detection circuit 13 according to an instruction from a user. In this case, the FM detection circuit 3 and AM detection circuit 13 correspond to the FM detection circuit 3 and AM detection circuit 13 shown in FIG. 1, respectively, which can be realized by the prior art.

A capacitor 4 is provided on the output side of the FM/AM switch 31, and cuts the DC component of a signal selected by the FM/AM switch 31. This capacitor 4 corresponds to the capacitor 4 shown in FIG. 1 provided to cut the DC component of the FM detected signal.

An FM/AM switch 32 guides a signal that passes though the capacitor 4, to a speaker according to an instruction from the user. When the FM/AM switch 31 selects the FM detected signal, the FM/AM switch 32 guides the signal that passes though the capacitor 4 to a stereo demodulation unit 5. When the FM/AM switch 31 selects the AM detected signal, the FM/AM switch 32 guides the signal that passes though the capacitor 4 to the speaker 6.

The resistors Ra, Rb and Rc are different from each other, and the resistors are electrically connected to a path for outputting the AM detected signal that passes through the capacitor 4. A low-cut frequency switch (second switch) 33 selects a corresponding resistor from the resistors Ra through Rc according to a control signal generated by a control circuit 34, and AC-grounds the resistor. When the low-cut frequency switch 33 selects no resistor, that is, constitutes no high-pass filter composed of the capacitor and the resistor, the switch 33 selects “open”. The control circuit 34 may be realized by, for example, a microcomputer. Furthermore, as shown in FIG. 3, the control signal for selecting a desired resistor from the three resistors may be realized, for example, by two-bit data. Although in FIG. 3, three resistors (Ra-Rc) are provided, the number of resistors is not limited to three, and may be two or may be four or more.

In a radio receiver provided with the low frequency attenuation circuit, if a user selects “FM”, the FM/AM switch 31 selects an FM detected signal outputted from the FM detection circuit 3, and the FM/AM switch 32 guides the signal that passes through the capacitor 4 to the stereo demodulation unit 5. In this case, the capacitor 4 operates as a DC cut condenser to cut DC component from the FM detected signal. Here, the status of the low-cut frequency switch 33 is not limited.

On the other hand, if a user selects “AM”, the FM/AM switch 31 selects an AM detected signal outputted from the AM detection circuit 13, and the FM/AM switch 32 guides the signal that passes through the capacitor 4 to the speaker 6. The low-cut frequency switch 33 selects a resistor from among the resistors Ra through Rc according to the control signal from the control circuit 34. Thus, a high-pass filter is constituted by the capacitor 4 and the selected resistor. Specifically, if the resistor Ra is selected, a high-pass filter composed of the capacitor 4 and the resistor Ra is formed. If the resistor Rc is selected, a high-pass filter composed of the capacitor 4 and the resistor Rc is formed. Then, this high-pass-filter attenuates the low frequency component of an AM detected signal.

In a case where none of the resistors Ra through Rc is selected, DC component of the AM detected signal is cut only by the capacitor 4, similar to the case of FM detected signal.

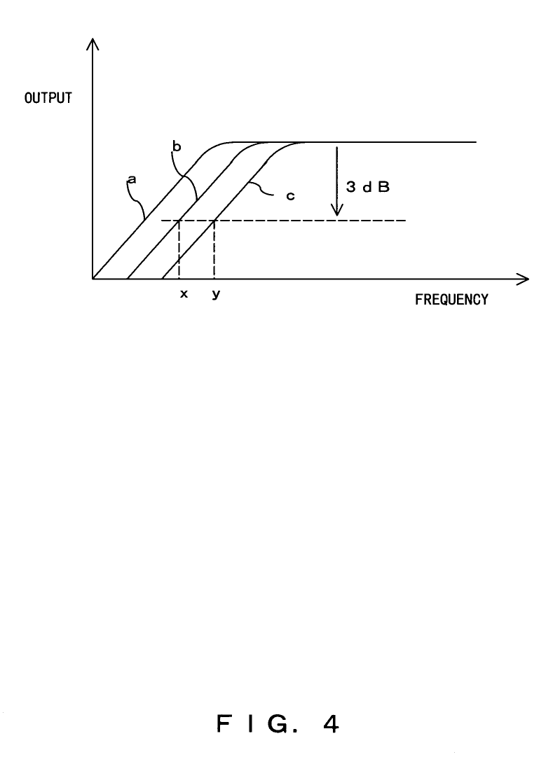

FIG. 4 shows the characteristic of the above-mentioned high-pass filter. Characteristics“a”, “b” and “c” shown in FIG. 4 represent the respective filter characteristics when resistors Ra, Rb and Rc is selected, respectively. As described above, the characteristic of a high-pass filter (in this case, cut-off frequency or low -cut frequency) can be adjusted by appropriately selecting a resistor.

The characteristic of a high-pass filter is adjusted as follows. It is known that in an AM receiver, hearing sense can be improved by attenuating a component of a frequency band lower than a prescribed frequency (such as approximately 100 Hz). Therefore, in the low frequency attenuation circuit of the present invention, an appropriate resistor is selected from the resistors Ra through Rc in such a way that the cut-off frequency of the high-pass filter may become approximately the prescribed frequency.

In this case, if the cut-off frequency is fixed, there is no need to prepare a plurality of resistors (Ra-Rc), and a suitable hearing sense will be obtained by providing a resistor corresponding to the cut-off frequency in advance. However, a cut-off frequency by which an optimal hearing sense is obtained cannot be fixed due to the different characteristics of a variety of elements constituting a radio receiver. Therefore, it is preferable to adjust the cut-off frequency of the high-pass filter before the shipment of each radio receiver.

For example, if in FIG. 4 it is assumed that a cut-off frequency by which an optimal hearing sense can be obtained is “x”, the control circuit 34 transmits a control signal indicating that resistor Rb must be selected in order to obtain characteristic “b”, to the low-cut frequency switch 33. In this example, characteristic “b” indicates a characteristic that an input signal is attenuated by a prescribed amount (for example, 3 dB) at frequency x. If a cut-off frequency by which an optimal hearing sense can be obtained is “y”, the control circuit 34 transmits a control signal indicating that resistor Rc must be selected in order to obtain characteristic “c”, to the low-cut frequency switch 33. In this example, characteristic “c” indicates a characteristic that an input signal is attenuated by a prescribed amount (for example, 3 dB) at frequency y.

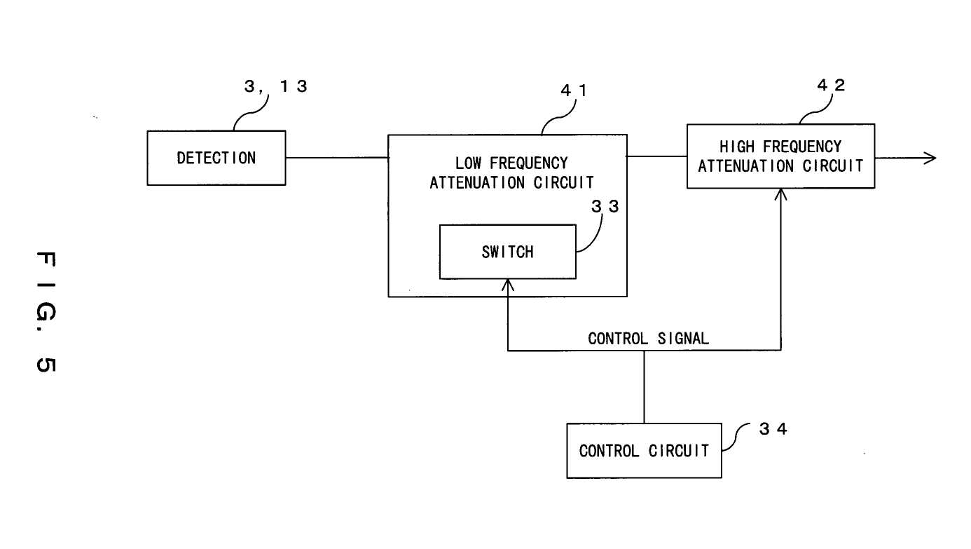

A radio receiver is generally provided with not only a function to attenuate the low frequency component of a detected signal (low frequency attenuation circuit 41) but also a function to attenuate its high frequency component (high frequency attenuation circuit 42), as shown in FIG. 5. In this case, the low frequency attenuation circuit 41 corresponds to the high-pass filter described with reference to FIG. 3. The high frequency attenuation circuit 42 corresponds to, for example, a low-pass filter and is a circuit for attenuating the high frequency component to improve hearing sense.

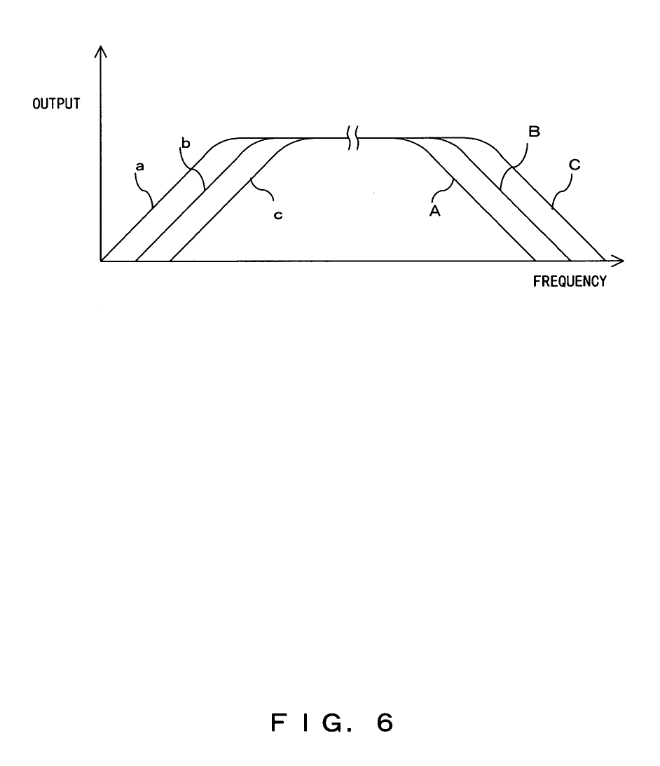

In the radio receiver, the control circuit 34 may link the low frequency attenuation circuit 41 with the high frequency attenuation circuit 42 and control them. For example, in FIG. 6, if the cut-off frequency of the high frequency attenuation circuit 42 is set at a lower frequency (characteristic A), the cut-off frequency of the low frequency attenuation circuit 41 is set at a higher frequency (characteristic c). Similarly, if the cut-off frequency of the high frequency attenuation circuit 42 is set at a higher frequency (characteristic C), the cut-off frequency of the low frequency attenuation circuit 41 is set at a lower frequency (characteristic a). In this case, as described above, the cut-off frequency of the low frequency attenuation circuit 41 can be realized by controlling the status of the low-cut frequency switch 33.

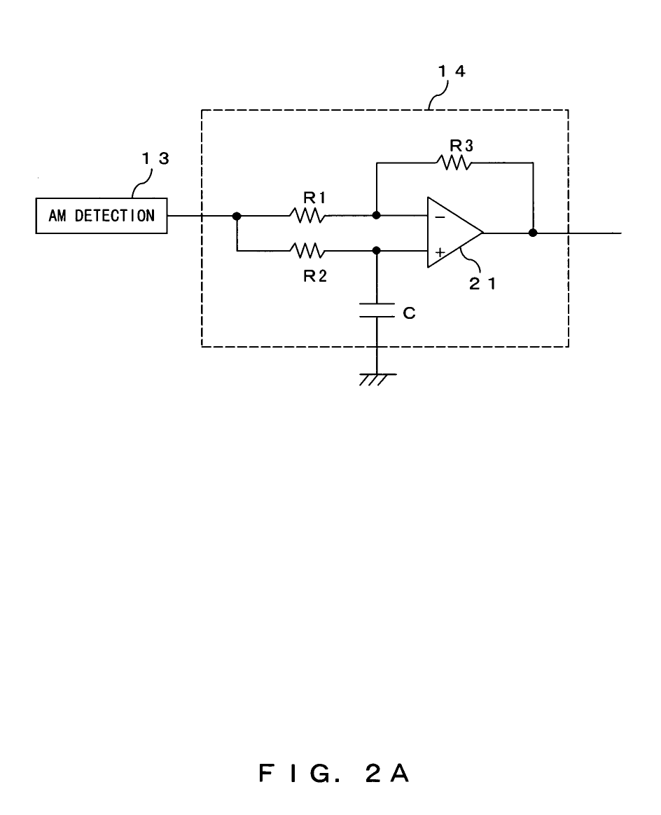

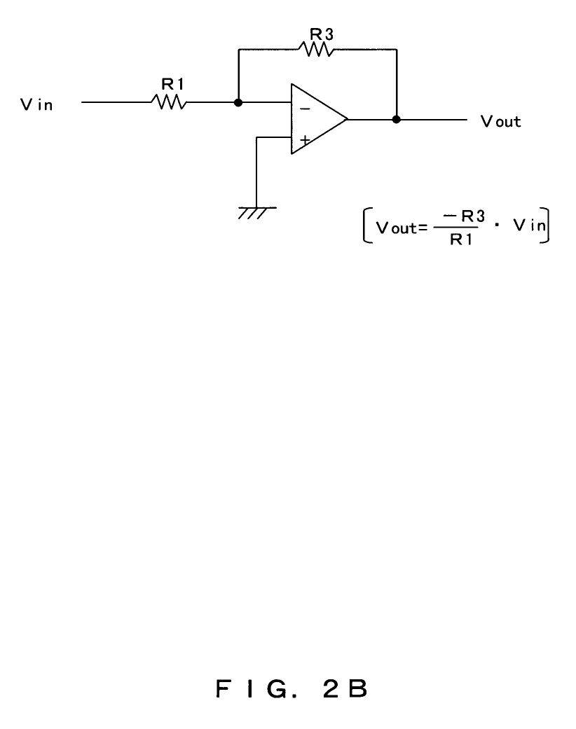

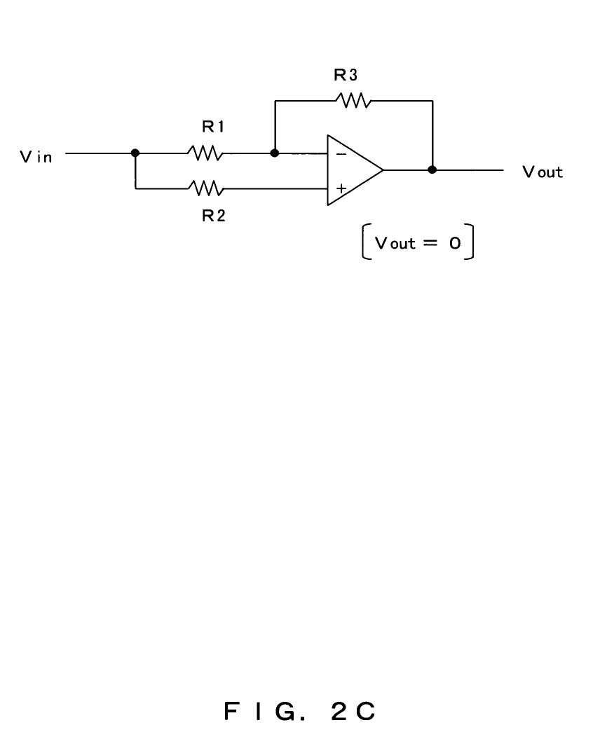

As described above, the low frequency attenuation circuit of the embodiment can be realized by a high-pass filter composed of the capacitor 4 and resistors Ra through Rc. The FM/AM switches 31 and 32, the resistors Ra through Rc and low-cut frequency switch 33 can be formed in one IC. The capacitor 4 is not newly provided in order to attenuate the low frequency component of an AM detected signal and can be realized by using a capacitor for cutting the DC component of an FM detected signal. Therefore, according to the low frequency attenuation circuit of the embodiment, there is no need of a capacitor with a large capacity provided only to attenuate the low frequency component of the AM detected signal unlike the existing circuit shown in FIG. 2A. As a result, the number of “external components” in the radio receiver becomes small, and the number of the input/output pins of the IC is also reduced. Thus, a small radio receiver can be realized, and its cost reduction can also be realized.

A cut-off frequency in the low frequency attenuation circuit can be adjusted by selecting an arbitrary resistor from a plurality of resistors, based on an instruction from a microcomputer or the like. In other words, a cut-off frequency can be adjusted inside the IC. As a result, a cut-off frequency can be easily adjusted. When the same adjustment is attempted in the existing circuit shown in FIG. 2A, the size of the capacitor C must be changed and it is inconvenient.

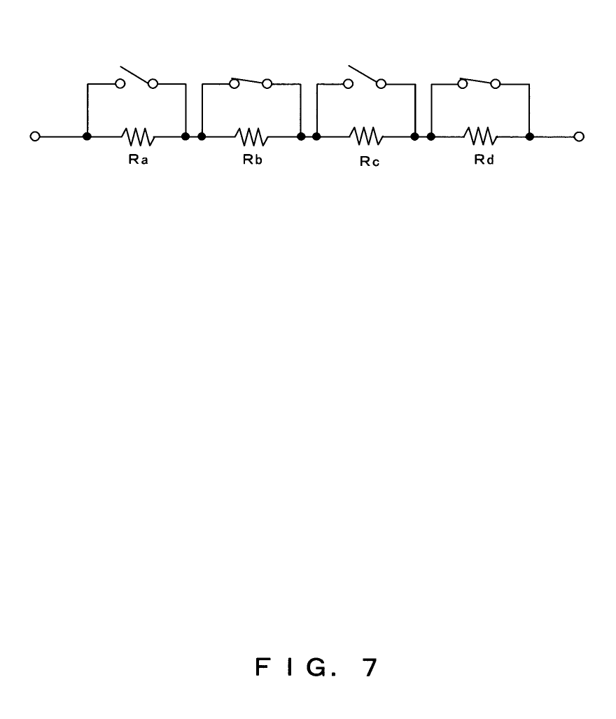

Although in the above-mentioned embodiment, one resistor is selected from a plurality of resistors, the present invention is not limited to this. Specifically, for example, as shown in FIG. 7, one or more resistors may be selected from the plurality of resistors in a resistance circuit including a plurality of resistors connected in series. In the example shown in FIG. 7, resistors Ra and Rc are selected from resistors Ra through Rd. In this case, the resistance value of this resistance circuit is “Ra+Rc”.

Although in the above-mentioned embodiment, the low frequency attenuation circuit attenuates the low frequency component of an AM detected signal, the present is not limited to this. Specifically, the low frequency attenuation circuit of the present invention can also be used to attenuate the low frequent component of an FM detected signal.

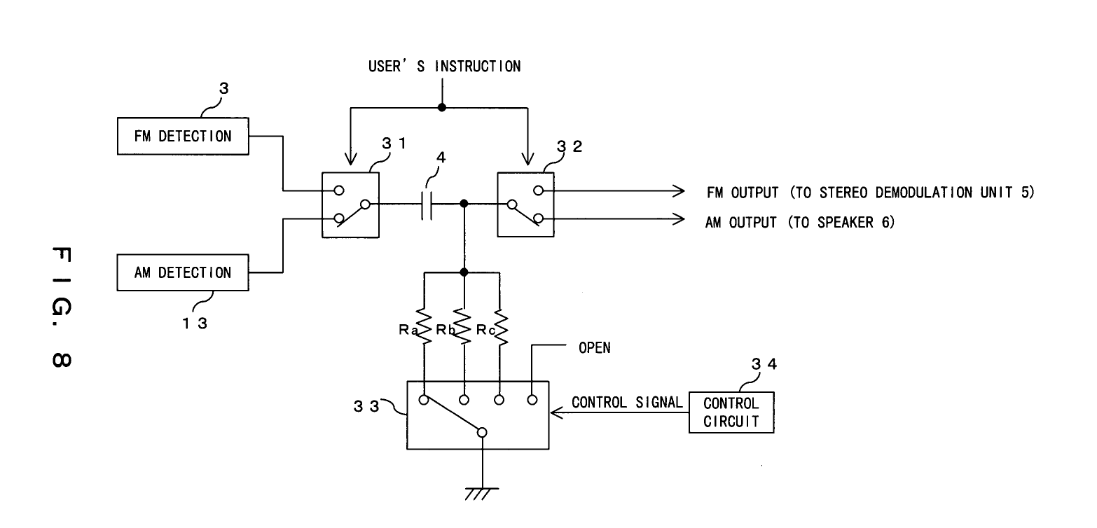

FIG. 8 shows the configuration of the low frequency attenuation circuit capable of selectively attenuating the low frequency component of an AM or FM detected signal. In FIGS. 3 and 8, the same reference numerals represent the same circuit element.

In the low frequency attenuation circuit shown in FIG. 8, resistors Ra through Rc are electrically connected to a path between the capacitor 4 and the FM/AM switch 32. Therefore, in this circuit, not only the low frequency component of an AM detected signal but also that of an FM detected signal can be attenuated. Specifically, if the FM/AM switch 31 selects an FM detected signal and the low-cut frequency switch 33 selects resistor Ra, the low frequency component of the FM detected signal is attenuated by a high-pass filter composed of the capacitor 4 and resistor Ra. If the FM/AM switch 31 selects an AM detected signal and the low-cut frequency switch 33 selects resistor Rc, the low frequency component of the AM detected signal is attenuated by a high-pass filter composed of the capacitor 4 and resistor Rc.

A radio receiver is sometimes provided with a function to dynamically adjust a cut-off frequency for cutting the high frequency component according to the receiving level in FM reception. In such a case, hearing sense can be improved by dynamically switching resistors Ra through Rc according to the adjustment of a cut-off frequency for cutting the high frequency component. Specifically, if a cut-off frequency for cutting the high frequency component is set at a higher frequency, a resistor may be selected in such a way that the cut-off frequency of the low frequency attenuation circuit is set at a lower frequency, accordingly. If a cut-off frequency for cutting the high frequency component is set at a lower frequency, a resistor may be selected in such a way that the cut-off frequency of the low frequency attenuation circuit is set at a higher frequency, accordingly.

According to the present invention, in an FM/AM radio receiver, the low frequency component of an FM/AM detected signal can be attenuated using a capacitor provided to cut the DC component of an FM detected signal. Therefore, there is no need to provide a capacitor only to be used for attenuating the low frequency component of an FM/AM detected signal. As a result, small circuit scale, circuit integration and the cost reduction of a radio receiver can be realized.

What is claimed is:

1. A low frequency attenuation circuit which is used in an FM/AM radio receiver, comprising:
a first switch for selecting an FM detected signal or an AM detected signal;
a capacitor provided on the output side of said first switch;
a plurality of resistors provided on the output side of said first switch; and
a second switch constituting a high-pass filter for the AM detected signal using a resistor selected from said plurality of resistors and said capacitor when said first switch selects the AM detected signal.

2. The low frequency attenuation circuit according to claim 1, wherein
said first switch, said plurality of resistors and said second switch are formed in an integrated circuit.

3. The low frequency attenuation circuit according to claim 1 or 2, further comprising
a high frequency attenuation circuit for attenuating high frequency component of a detected signal, wherein
said second switch selects a resistor from said plurality of resistors based on the operation of said high frequency attenuation circuit.

4. A low frequency attenuation circuit which is used in an FM/AM radio receiver, comprising:
a first switch for selecting an FM detected signal or an AM detected signal;
a capacitor provided on the output side of said first switch;
resistor means provided on the output side of said first switch;
a control circuit for controlling the resistance of said resistor means;
a second switch for constituting a high-pass filter for the AM detected signal using said resistor means and said capacitor when said first switch selects the AM detected signal, wherein
said control circuit controls the resistance of said resistor means so that the cut-off frequency of the high-pass filter is a prescribed frequency which is determined based on the hearing sense of voice reproduced from the AM detected signal.

5. An FM/AM radio receiver, comprising:
an FM detection circuit for generating an FM detected signal from a received wave;
an AM detection circuit for generating an AM detected signal from the received wave;
a first switch for selecting the FM detected signal or the AM detected signal;
a capacitor provided on the output side of said first switch;
a plurality of resistors provided on the output side of said first switch; and
a second switch for constituting a high-pass filter for the AM detected signal using a resistor selected from said plurality of resistors and said capacitor when said first switch selects the AM detected signal.

6. A low frequency attenuation circuit which is used in an FM/AM radio receiver, comprising:
a first switch for selecting an FM detected signal or an AM detected signal;
a capacitor provided on the output side of said first switch;
a plurality of resistors provided on the output side of said first switch; and
a second switch constituting a high-pass filter for the AM detected signal using a resistor selected from said plurality of resistors and the capacitor when said first switch selects the AM detected signal, and constituting a high-pass filter for the FM detected signal using a resistor selected from said plurality of resistors and said capacitor when said first switch selects the FM detected signal.

7. The low frequency attenuation circuit according to claim 6, further comprising
a high frequency attenuation circuit for attenuating high frequency component of a detected signal, wherein
said second switch selects a resistor from said plurality of resistors based on the operation of said high frequency attenuation circuit.
